(19) United States
(12) Patent Application Publication
(10) Pub. No.: US 2009/0062350 A1
(43) Pub. Date: Mar. 5, 2009

(54) Pesticidal composition

(75) Inventor: Naoki Tsuda, Toyonaka-shi (JP)

Correspondence Address: FOLEY AND LARDNER LLP;SUITE 500, 3000 K STREET NW, WASHINGTON, DC, 20007, US

(73) Assignee: Sumitomo Chemical Company, Limited

(21) Appl. No.: 12/230,752

(22) Filed: Sep. 4, 2008

(30) Foreign Application Priority Data
Sep. 5, 2007 (JP) 2007-229644

(51) Int. Cl. A01N 43/40; A01P 7/04

(52) U.S. Cl. 514/345

(57) ABSTRACT

A pesticidal composition including a microcapsule in which an oil containing a pesticidal active ingredient and an organic solvent is covered with a wall made of a thermosetting resin; at least one kind selected from the group consisting of polyglycerin fatty acid ester, sucrose fatty acid ester and alkylbenzenesulfonic acid or its salt; a thickener, and water is provided. The pesticidal composition has elution performance suited for an applied situation without the need of changing the design of the microcapsule itself As the thermosetting resin, a polyurethane resin or a polyurea resin is preferred. As the pesticidal active ingredient, an insect growth regulating active ingredient such as 4-phenoxyphenyl 2-(2-pyridyloxy)propyl ether can be recited.

### BACKGROUND OF THE INVENTION

1. Field of the Invention

The present invention relates to a pesticidal composition, and more specifically to an aqueous suspended pesticidal composition in which a microcapsule containing a pesticidal active ingredient is dispersed in water.

2. Description of the Background Art

As a pesticidal formulation technique for controlling efficacy of a pesticidal active ingredient and imparting various performances, microcapsule (MC) formulations have been researched and developed, and brought into practical use. As for these formulations; material quality and a wall thickness of a wall material are designed depending on the required performances such as improvement in stability of a pesticidal active ingredient, reduction in phytotoxicity, reduction in toxicity at the time of application and improvement in residual activity, and a pesticidal active ingredient encapsulated therein.

For example, Japanese Patent Laying-Open No. 8-53306 discloses a pesticidal composition in which a pesticidal active ingredient is microcapsulated, wherein a wall of the microcapsule is a polyurethane resin or a polyurea resin containing an isocyanurate structure. Japanese Patent Laying-Open No. 2005-247696 discloses a microcapsulated insect growth regulator wherein an insect growth regulating active ingredient is encapsulated in a polyurethane wall or a polyurea wall which is defined by specific numerical values of an average particle size, a wall thickness and a ratio of wall thickness/average particle size. Japanese Patent Laying-Open No. 2007-63181 discloses an aqueous suspended composition in which a microcapsule involving a hydrophobic liquid containing a pesticidal active ingredient and having a specific volume particle size is dispersed in water.

### SUMMARY OF THE INVENTION

In a microcapsule formulation having a wall made of the thermosetting resin (polyurethane resin, polyurea resin and the like), since required elution performance differs depending on an applied situation, it is necessary to change the design of the microcapsule itself, such as selection of a wall substance and adjustment of a wall thickness. However, changing the design of the microcapsule itself is complicated and troublesome.

Therefore, it is an object of the present invention to provide a pesticidal composition containing a microcapsule realizing elution performance suited for an applied situation, without the need of changing the design of the microcapsule itself.

The inventor of the present application made diligent efforts to achieve the above object, and found that in an aqueous suspended pesticidal composition prepared by adding a thickener and a specific ingredient to a slurry of a microcapsule in which an oil containing a pesticidal active ingredient and an organic solvent is covered with a wall made of a thermosetting resin, elution of the pesticidal active ingredient from the microcapsule after spraying is suppressed, and sustained releasability improves, and accomplished the present invention.

That is, the present invention provides a pesticidal composition including a microcapsule in which an oil containing a pesticidal active ingredient and an organic solvent is covered with a wall made of a thermosetting resin, at least one kind selected from the group consisting of polyglycerin fatty acid ester, sucrose fatty acid ester and alkylbenzenesulfonic acid, or its salt, a thickener, and water.

As the thermosetting resin, a polyurethane resin or a polyurea resin is preferred. As the pesticidal active ingredient, an insect growth regulating active ingredient such as 4-phenoxyphenyl 2-(2-pyridyloxy)propyl ether can be recited.

Since the pesticidal composition of the present invention contains at least one ingredient selected from the group consisting of polyglycerin fatty acid ester, sucrose fatty acid ester and alkylbenzenesulfonic acid or its salt, in an aqueous suspension containing a microcapsule encapsulating a pesticidal active ingredient and a thickener, elution of the pesticidal active ingredient outside the microcapsule after spraying onto solid phase surface or the like is significantly suppressed, and high sustained releasability is executed. Therefore, the chemical efficacy is maintained for a long time, so that the application amount and the number of application times can be reduced, and phytotoxicity can be reduced. Further, since elution of the pesticidal active ingredient from the microcapsule can be controlled by adjusting, for example, a use amount of polyglycerin fatty acid ester, sucrose fatty acid ester or alkylbenzenesulfonic acid or its salt, it is possible to realize elution performance suited for the applied situation without changing the design of the microcapsule itself

### DESCRIPTION OF THE PREFERRED EMBODIMENTS

The pesticidal composition of the present invention includes a microcapsule in which an oil containing a pesticidal active ingredient and an organic solvent is covered with a wall made of a thermosetting resin, at least one kind of ingredient selected from the group consisting of polyglycerin fatty acid ester, sucrose fatty acid ester and alkylbenzenesulfonic acid or its salt, a thickener, and water.

The pesticidal active ingredient used in the present invention is not particularly limited insofar as it is able to form a stable liquid state by being dissolved or dispersed in an organic solvent, in particular, in a hydrophobic organic solvent. As such a pesticidal active ingredient, compounds which are active ingredients of insect growth regulators, insecticides, fungicides, herbicides, plant growth regulators can be recited, and representative examples are as listed below. These pesticidal active ingredients may be used singly or in combination of two or more kinds.

Fenitrothion, fenthion, diazinon, chlorpyrifos, acephate, methidathion, disulfoton, DDVP, sulprofos, cyanophos, dioxabenzofos, dimethoate, phenthoate, malathion, trichlorfon, azinphosmethyl, monocrotophos, ethion;

BPMC, benfuracarb, propoxur, carbosulfan, methomyl, ethiofencarb, aldicarb, oxamyl, fenothiocarb;

etofenprox, fenvalerate, esfenvalerate, fenpropathrin, cypermethrin, permethrin, cyhalothrin, deltamethrin, cycloprothrin, fluvalinate, bifenthrin, halfenprox, tralomethrin, silafluofen, d-phenothrin, cyphenothrin, d-resmethrin, acrinathrin, cyfluthrin, tefluthrin, transfluthrin, tetramethrin, allethrin, prallethrin, empenthrin imiprothrin, d-furamethrin;

buprofezin, cartap, thiocyclam, bensultap;

endosulfan, γ-BHC, dicofol, chlorfluazron, teflubenzuron, flufenoxuron;

amitraz, chlordimeform, diafenthiuron, metoxadiazone, bromopropylate, tetradifon, chinomethionat, propargite, fenbutatin oxide, hexythiazox, clofentezine, pyridaben, fenpyroximate, tebufenpyrad, tetranactin, dinactin, trinactin, pyrimidifen, milbemectin, abamectin, ivermectin, azadirachtin;

methoprene, hydroprene, pyriproxyfen, kinoprene, ethoprene, diflubenzuron, triflumuron, hexaflumuron, lufenuron, novaluron;

cyromazine, tebufenozide, chromafenozide, methoxyfenozide, halofenozide;

5-methyl-1,2,4-triazolo[3,4-b]benzothiazole, methyl 1-(butylcarbamoyl)benzimidazole-2-carbamate, 6-(3,5-dichloro-4-methylphenyl)-3(2H)-pyridazinone, 1-(4-chlorophenoxy)-3,3-dimethyl-1-(1H-1,2,4-triazole-1-yl)butanone, (E)-4-chloro-2-(trifluoromethyl)-N-[1-(imnidazole-1-yl)-2-propoxyethylidene]aniline, 1-[N-propyl-N-[2-(2,4,6-trichlorophenoxy)ethyl]carbamoyl]imidazole, (E)-1-(4-chlorophenyl)-4,4-dimethyl-2-(1H-1,2,4-triazole-1-yl)-1-pentene-3-ol, 1-(4-chlorophenyl)-4,4-dimethyl-2-(1H-,1,2,4-triazole-1-yl)pentane-3-ol, (E)-1-(2,4-dichlorophenyl)-4,4-dimethyl-2-(1H-1,2,4-triazole-1-yl)-1-pentene-3-ol, 1-(2,4-dichlorophenyl)-4,4-dimethyl-2-(1H-1,2,4-triazole-1-yl)-pentane-3-ol, 4-[3-(4-tert-butylphenyl)-2-methylpropyl]-2,6-dimethylmorpholine, 2-(2,4-dichlorophenyl)-1-(1H-1,2,4-triazole-1-yl)hexane-2-ol, O,O-diethyl O-2-quinoxalyl phosphorothioate, O-(6-ethoxy-2-ethyl-4-pyrimidinyl) O,O-dimethyl phosphorothioate, 2-diethylamino-5,6-dimethylpyrimidine-4-yl dimethyl carbamate, 4-(2,4-dichlorobenzoyl)-1,3-dimethyl-5-pyrazolyl p-toluenesulfonate, 4-amino-6-(1,1-dimethylethyl)-3-methylthio-1,2,4-triazine-5(4H)-one, 2-chloro-N-[(4-methoxy-6-methyl-1,3,5-triazine-2-yl)aminocarbonyl]benzenesulfonamide, 2-methoxycarbonyl-N-[(4,6-dimethoxypyrmidine-2-yl)aminocarbonyl]benzenesulfonamide, 2-methoxycarbonyl-N-[(4,6-dimethylpyrimidine-2-yl)aminocarbonyl]benzenesulfonamide, 2-methoxycarbonyl-N-[(4-methoxy-6-methyl-1,3,5-triazine-2-yl) aminocarbonyl]benzenesulfonamide, 2-ethoxycarbonyl-N-[(4-chloro-6-methoxypyrimidine-2-yl)aminocarbonyl]benzenesulfonamide, 2-(2-chloroethoxy)-N-[(4-methoxy-6-methyl-1,3,5-triazine-2-yl)aminocarbonyl]benzenesulfonamide, 2-methoxycarbonyl-N-[(4,6-dimethoxypyrimidine-2-yl)aminocarbonyl]phenylmethanesulfonamide, 2-methoxycarbonyl-N-[(4-methoxy-6-methyl-1,3,5-triazine-2-yl)aminocarbonyl]thiophene-3-sulfonamide, 4-ethoxycarbonyl-N-[(4,6-dimethoxypyrimidine-2-yl)aminocarbonyl]-1-methylpyrazole-5-sulfonamide, 2-[4,5-dihydro-4-methyl-4-(1-methylethyl)-5-oxo-1H-imidazole-2-yl]-3-quinolinecarboxylic acid, 2-[4,5-dihydro-4-methyl-4-(1-methylethyl)-5-oxo-1H-imidazole-2-yl]-5-ethyl-3-pyridine carboxylic acid, methyl 6-(4-isopropyl-4-methyl-5-oxoimidazoline-2-yl)-m-toluate, methyl 2-(4-isopropyl-4-methyl-5-oxoimidazoline-2-yl)-p-toluate, 2-(4-isopropyl-4-methyl-5-oxoimidazoline-2-yl)nicotinic acid, N-(4-chlorophenyl)methyl-N-cyclopentyl-N′-phenyl urea;

propionaldehyde oxime O-2-(4-phenoxyphenoxy)ethyl ether, propionaldehyde oxime O-2-(4-phenoxyphenoxy)propyl ether, 1-(4-ethylphenoxy)-6,7-epoxy-3,7-dimethyl-2-octene, N-[[[5-(4-bromophenyl)-6-methyl-2-pyrazinyl]amino]carbonyl]-2,6-dichlorobenzaldehyde, N-[[[3,5-dichloro-4-(1,1,2,2-tetrafluoroethoxy)phenyl]amino]carbonyl]-2,6-difluorobenzaldehyde, 1-(2,6-difluorobenzoyl)-3-[2-fluoro-4-(1,1,2,2-tetrafluoroethoxy)phenyl]urea, 1-(2,6-difluorobenzoyl)-3-(2-fluoro-4-trifluoromethylphenyl)urea; and

5-(2-propynyl)furfuryl 2,2,3,3-tetramethylcyclopropane carboxylate, N-cyano-N′-methyl-N′-(6-chloro-3-pyridylmethyl)acetamidine.

Among these, insect growth regulating ingredients (insect juvenoides such as dodecadienoate compounds, oxime ether compounds, pyridyl ether compounds and carbamate compounds, insect chitin-synthesis inhibiting compounds such as benzoylphenyl urea compounds, and so on) such as buprofezin, chlorfluazron, teflubenzuron, flufenoxuron, methoprene, hydroprene, pyriproxyfen, kinoprene, ethoprene, diflubenzuron, triflumuron, hexaflumuron, lufenuron, novaluron, cyromazine, tebufenozide, chromafenozide, methoxyfenozide, halofenozide, propionaldehyde oxime O-2-(4-phenoxyphenoxy) ethyl ether, propionaldehyde oxime O-2-(4-phenoxyphenoxy) propyl ether, 1-(4-ethylphenoxy)-6,7-epoxy-3,7-dimethyl-2-octene, N-[[[5-(4-bromophenyl)-6-methyl-2-piradinyl]amino]carbonyl]-2,6-dichlorobenzaldehyde, N-[[[3,5-dichloro-4-(1,1,2,2-tetrafluoroethoxy)phenyl]amino]carbonyl]-2,6-difluorobenzaldehyde, 1-(2,6-difluorobenzoyl)-3-[2-fluoro-4-(1,1,2,2-tetrafluoroethoxy)phenyl]urea, 1-(2,6-difluorobenzoyl)-3-(2-fluoro-4-trifluoromethylphenyl)urea and the like are preferred, and particularly preferred is pyriproxyfen [=4-phenoxyphenyl 2-(2-pyridyloxy)propyl ether].

A content of the pesticidal active ingredient in the oil in the microcapsule differs depending on the kind of the pesticidal active ingredient, kind of the organic solvent and the like, and is generally about 5 to 90% by weight, preferably about 10 to 60% by weight, and more preferably about 20 to 50% by weight of the entire oil. The pesticidal composition of the present invention is generally used after being diluted, for example, with water of about 1 to 10000 times by weight, in spraying onto a plant or soil.

As the organic solvent, hydrophobic organic solvents are preferred, and for example, aromatic hydrocarbons, aliphatic hydrocarbons, aromatic carboxylic acid esters, and aliphatic carboxylic acid esters can be recited.

Examples of the aromatic hydrocarbons include alkylbenzene such as toluene, xylene and ethylbenzene; alkylnaphthalene such as methylnaphthalene and dimethylnaphthalene; and diarylalkanes such as phenylxylylethane. As the aromatic hydrocarbons, commercially available solvents may be used. Examples of such commercially available solvents include trade name “Hisol SAS-296” (mixture of 1-phenyl-1-xylylethane and 1-phenyl-1-ethylphenylethane, available from Nippon Oil Corporation), trade name “CACTUS SOLVENT HP-MN” (methylnaphthalene 80%, available from Nikko Petrochemicals Co., Ltd.), trade name “CACTUS SOLVENT HP-DMN” (dimethylnaphthalene 80%, available from Nikko Petrochemicals Co., Ltd.), trade name “CACTUS SOLVENT P-100” (alkylbenzene having 9 to 10 carbons, available from Nikko Petrochemicals Co., Ltd.), trade name “CACTUS SOLVENT P-150” (alkylbenzene, available from Nikko Petrochemicals Co., Ltd.), trade name “CACTUS SOLVENT P-180” (mixture of methylnaphthalene and dimethylnaphthalene, available from Nikko Petrochemicals Co., Ltd.), trade name “CACTUS SOLVENT P-200” (mixture of methylnaphthalene and dimethylnaphthalene, available from Nikko Petrochemicals Co., Ltd.), trade name “CACTUS SOLVENT P-220” (mixture of methylnaphthalene and dimethylnaphthalene, available from Nikko Petrochemicals Co., Ltd.), trade name “CACTUS SOLVENT PAD-1” (dimethylmonoisopropylnaphthalene, available from Nikko Petrochemicals Co., Ltd.), trade name “Solvesso 100” (aromatic hydrocarbon, available from Exxon Chemical Company), trade name “Solvesso 150” (aromatic hydrocarbon, available from Exxon Chemical Company), trade name “Solvesso 200” (aromatic hydrocarbon, available from Exxon Chemical Company), trade name “Swasol 100” (toluene, available from Maruzen Petrochemical Co., Ltd.), and trade name “Swasol 200” (xylene, available from Maruzen Petrochemical Co., Ltd.) can be exemplified.

As the aliphatic hydrocarbons, for example, linear aliphatic hydrocarbons such as pentane, hexane, heptane, octane, 2-ethylhexane, nonane, decane, dodecane, pentadecane, hexadecane, heptadecane, octadecane, nonadecane and eicosane; cyclic aliphatic hydrocarbons such as cyclopropane, cyclobutane, cyclopentane and cyclohexane; and liquid paraffin which is a mixture thereof can be recited.

As the aromatic carboxylic acid ester, for example, methyl benzoate, ethyl benzoate, and propyl benzoate can be recited.

As the aliphatic carboxylic acid ester, adipic acid dialkyl ester such as dibutyl adipate and dioctyl adipate can be exemplified. As the aliphatic carboxylic acid ester, commercially available solvents may be used. Examples of such commercially available solvents include trade name “VINYCIZER 40” (diisobutyl adipate, available from Kao Corporation), and trade name “VINYCIZER 50” (diisodecyl adipate, available from Kao Corporation).

The organic solvent may be used singly or in combination of two or more kinds. As the organic solvent, combination of aromatic hydrocarbon and aliphatic carboxylic acid ester (particularly adipic acid dialkyl ester) is preferred from the viewpoint of dissolubility of the pesticidal active ingredient and elutability of the pesticidal active ingredient outside the microcapsule. In this case, ratio of aromatic hydrocarbon and aliphatic carboxylic acid ester is, for example, former/latter (weight ratio)=about 5/95 to 95/5, preferably former/latter (weight ratio)=about 30/70 to 90/10, and more preferably former/latter (weight ratio)=about 50/50 to 85/15.

As the wall material that forms a wall of the microcapsule, for example, thermosetting resins such as a polyurethane resin, a polyurea resin, an urea formalin resin, a melamine urea resin, a phenol formalin resin and the like are used. In the present invention, a wall material capable of forming a wall by interfacial polymerization at the interface between the oil (hydrophobic liquid) containing a pesticidal active ingredient and water is preferred, and a polyurethane resin or a polyurea resin is particularly preferred.

The polyurethane resin is a resin generating through a reaction between a polyisocyanate compound and a polyol compound, and the polyurea resin is a resin generating through a reaction between a polyisocyanate compound and a polyamine compound. Examples of the polyisocyanate compound include hexamethylene diisocyanate, an adduct of hexamethylene diisocyanate and trimethylolpropane, a biuret condensate of three molecules of hexamethylene diisocyanate, an adduct of tolylene diisocyanate and trimethylol propane, an isocyanurate condensate of tolylene diisocyanate, an isocyanurate condensate of hexamethylene diisocyanate, an isocyanurate condensate of isophorone diisocyanate, isocyanate prepolymer in which one of isocyanate moieties of hexamethylene diisocyanate forms an isocyanurate structure together with two molecules of tolylene diisocyanate, and the other of isocyanate moieties forms an isocyanurate body together with two molecules of hexamethylene diisocyanate, 4,4′-methylenebis(cyclohexyl isocyanate), and trimethylhexamethylene diisocyanate. Among these, an adduct of tolylene diisocyanate and trimethylolpropane, an adduct of hexamethylene diisocyanate and trimethylolpropane, a biuret condensate of three molecules of hexamethylene diisocyanate, and a multivalent isocyanate having an isocyanurate structure (isocyanurate-type polyvalent isocyanate) are preferable.

As the polyol compound, for example, alkylene glycols having about 2 to 6 carbons such as ethylene glycol, propylene glycol and butylene glycol; and cycloalkylene glycols having about 3 to 10 carbons such as cyclopropylene glycol can be recited. As the polyamine compound, for example, alkylenediamines having about 2 to 10 carbons such as ethylenediamine and hexamethylenediamine; and polyalkylenepolyamines having about 4 to 12 carbons such as diethylenetriamine and triethylenetetramine can be exemplified.

An average particle size of a microcapsule is, for example, 1 to 50 μm, and preferably 10 to 40 μm. The average particle size of a microcapsule can be measured by a laser-type particle size distribution meter. Wall thickness of wall of the microcapsule is, for example, 5 to 50 nm, and preferably 10 to 40 nm.

A significant feature of the present invention is containing at least one kind of ingredient selected from the group consisting of polyglycerin fatty acid ester, sucrose fatty acid ester and alkylbenzenesulfonic acid or its salt, in a pesticidal composition.

As the polyglycerin fatty acid ester used in the present invention, for example, polyglycerin C₁₂₋₂₂ saturated or unsaturated fatty acid esters such as decaglycerin lauric acid ester, decaglycerin myristic acid ester, decaglycerin palmitic acid ester, decaglycerin stearic acid ester, decaglycerin behenic acid ester, decaglycerin oleic acid ester, decaglycerin linoleic acid ester, decaglycerin linolenic acid ester, and decaglycerin erucic acid ester can be recited. A degree of polymerization of polyglycerin in the polyglycerin fatty acid ester is about 2 to 20. The polyglycerin fatty acid ester may be used singly or in combination of two or more kinds.

As the polyglycerin fatty acid ester, a commercially available product may be used. Concrete examples of the commercially available polyglycerin fatty acid ester include Ryoto (trademark) polyglyester series (trade name available from Mitsubishi-Kagaku Foods Corporation.): L-7D (polyglycerin (10) lauric acid ester), L-10D (polyglycerin (10) lauric acid ester), M-7D (polyglycerin (10) myristic acid ester), M-10D (polyglycerin (10) myristic acid ester), P-8D (polyglycerin (10) palmitic acid ester), SWA-10D (polyglycerin (10) stearic acid ester), SWA-15D (polyglycerin (10) stearic acid ester), SWA-20D (polyglycerin (10) stearic acid ester), S-24D (polyglycerin (10) stearic acid ester), S-28D (polyglycerin (10) stearic acid ester), O-15D (polyglycerin (10) oleic acid ester), O-50D (polyglycerin (10) oleic acid ester), B-70D (polyglycerin (10) behenic acid ester), B-100D (polyglycerin (10) behenic acid ester), ER-60D (polyglycerin (10) erucic acid ester), LOP-120DP (polyglycerin mixed fatty acid ester); and SY Glyster series (trade name available from Sakamoto Yakuhin Kogyo Co., Ltd.): MSW-7S (decaglycerin monostearic acid ester), MS-5S (hexaglycerin monostearic acid ester), PS-3S (tetraglycerin pentastearic acid ester), PO-5S(hexaglycerin pentaoleic acid ester), ML-750 (decaglycerin monolauric acid ester).

As the sucrose fatty acid ester, for example, sucrose C₁₂₋₂₂ saturated or unsaturated fatty acid esters such as sucrose lauric acid ester, sucrose myristic acid ester, sucrose palmitic acid ester, sucrose stearic acid ester, sucrose oleic acid ester and the like can be recited. The sucrose fatty acid ester may be used singly or in combination of two or more kinds.

As the sucrose fatty acid ester, a commercially available product may be used. Concrete examples of the commercially available sucrose fatty acid ester include Ryoto (trademark) sugar ester series (trade name available from Mitsubishi-Kagaku Foods Corporation.): S-270 (sucrose stearic acid ester), S-570 (sucrose stearic acid ester), S-1170 (sucrose stearic acid ester), S-1670 (sucrose stearic acid ester), P-1670 (sucrose palmitic acid ester), M-1695. (sucrose myristic acid ester), O-170 (sucrose oleic acid ester), L-595 (sucrose lauric acid ester), L-1695 (sucrose lauric acid ester), B-370 (sucrose behenic acid ester); DK ester series (trade name available from Dai-ichi Kogyo Seiyaku Co., Ltd., sucrose stearic acid ester): SS, F-160, F-140, F-110, F-90, F-70, F50, F-20W, F-10, S-L18A and so on.

As the alkylbenzenesulfonic acid or its salt, for example, C₁₀₋₁₈ alkylbenzenesulfonic acids such as decylbenzenesulfonic acid, undecylbenzenesulfonic acid, dodecylbenzenesulfonic acid, tridecylbenzenesulfonic acid and tetradecylbenzene sulfonic acid; alkaline earth metal salts of C₁₀₋₁₈ alkylbenzenesulfonic acid such as calcium C₁₀₋₁₈ alkylbenzenesulfonate (for example, calcium decylbenzenesulfonate, calcium undecylbenzenesulfonate, calcium dodecylbenzenesulfonate, calcium tridecylbenzenesulfonate, calcium tetradecylbenzenesulfonate and the like); alkaline metal salts of C₁₀₋₁₈ alkylbenzenesulfonic acid such as sodium C₁₀₋₁₈ alkylbenzenesulfonate (for example, sodium decylbenzenesulfonate, sodium undecylbenzenesulfonate, sodium dodecylbenzenesulfonate, sodium tridecylbenzenesulfonate, sodium tetradecylbenzenesulfonate and the like); and amine salts (such as triethanol amine salt) of C₁₀₋₁₈ alkylbenzenesulfonic acid such as triethanolamine dodecylbenzenesulfonate can be recited. The alkylbenzenesulfonic acid or its salt includes branched-chain alkylbenzenesulfonic acid or its salt, and straight-chain alkylbenzenesulfonic acid or its salt. The alkylbenzenesulfonic acid or its salt may be used singly or in combination of two or more kinds.

As the alkylbenzenesulfonic acid or its salt, a commercially available product may be used. As the commercially available alkylbenzenesulfonic acid or its salt, for example, Pionin series (trade name, available from Takemoto Oil & Fat Co., Ltd.): A-40-S (straight-chain alkylbenzenesulfonic acid), A-40 (branched-chain alkylbenzenesulfonic acid), A-41-BN (branched alkylbenzenesulfonic acid salt), A-41-C (branched alkylbenzenesulfonic acid salt), A-41-B (branched alkylbenzenesulfonic acid salt); Lunox series (trade name, available from Toho Chemical Industry Co., Ltd.): S-40TD (triethanolamine dodecylbenzenesulfonate), S-100 (sodium dodecylbenzenesulfonate): Neogen series (trade name available from Dai-ichi Kogyo Seiyaku Co., Ltd.): SC-F (straight-chain sodium dodecylbenzenesulfonate), SC-A (sodium dodecylbenzenesulfonate), R-K (branched-chain sodium dodecylbenzenesulfonate), T-60 (triethanolamine dodecylbenzenesulfonate) and the like can be recited.

A use amount of at least one kind of ingredient selected from the group consisting of polyglycerin fatty acid ester, sucrose fatty acid ester and alkylbenzenesulfonic acid or its salt may be selected depending on a desired elution speed or an elution amount of the pesticidal active ingredient. The total use amount of the ingredient is, for example, about 20 to 5000 parts by weight, preferably about 50 to 2000 parts by weight, and more preferably about 100 to 1000 parts by weight, relative to 100 parts by weight of the oil in the microcapsule, and is, for example, about 50 to 10000 parts by weight, preferably about 100 to 5000 parts by weight, and more preferably about 250 to 2500 parts by weight, relative to 100 parts by weight of the pesticidal active ingredient in the microcapsule. By adjusting a kind and a use amount of the ingredient, it is possible to control an elution speed or an elution amount of the pesticidal active ingredient in the microcapsule.

In the pesticidal composition of the present invention, the contents of the pesticidal active ingredient and the organic solvent are typically about 0.0001 to 0.03% by weight and 0.0002 to 0.06% by weight, respectively.

The amount of the wall substance is typically about 0.0009 to 0.01% by weight in the pesticidal composition of the present invention.

Further, the content of the polyglycerin fatty acid ester, the sucrose fatty acid ester and/or the alkylbenzenesulfonic acid or its salt is typically about 0.01 to 1% by weight.

As the thickener in the present invention, natural polysaccharides such as xanthan gum, rhamsan gum, locust bean gum, carrageenan and welan gum, synthetic polymers such as sodium polyacrylate, semi-synthetic polysaccharides such as carboxymethyl cellulose, micropowder of mineral substances such as aluminum magnesium silicate, smectite, bentonite, hectorite and dry-method silica, alumina sol and the like can be exemplified. The thickener may be used singly or in combination of two or more kinds. A use amount of the thickener is, for example, about 0.02 to 50 parts by weight, preferably about 0.2 to 20 parts by weight, and more preferably about 0.5 to 10 parts by weight, relative to 100 parts by weight of the oil in the microcapsule. A content of the thickener in the pesticidal composition is typically about 0.0009 to 0.0002% by weight. Addition of the thickener improves dispersion stability of the aqueous suspended pesticidal composition and allows adjustment of viscosity of the composition to a value suited for spraying or the like.

The amount of water is generally about 99.9 to 99.998% by weight in the pesticidal composition of the present invention.

The pesticidal composition of the present invention may be added with additives such as an antifreezing agent, an antiseptic agent and a weighting agent as necessary. As the antifreezing agent, for example, alcohols such as propyleneglycol can be recited. As the weighting agent, water-soluble salts such as sodium sulfate, and water-soluble fertilizers such as urea can be recited.

A viscosity of the pesticidal composition of the present invention (B type viscometer; Rotor No.2, 6 rpm, 20° C.) is generally 50 to 2000 mPa·s, and preferably 100 to 1500 mPa·s from the viewpoint of handlability and the like.

The pesticidal composition of the-present invention can be produced by containing a thickener and at least one kind of ingredient selected from the group consisting of polyglycerin fatty acid ester, sucrose fatty acid ester and alkylbenzenesulfonic acid or its salt, in a microcapsule slurry containing a microcapsule in which an oil containing a pesticidal active ingredient and an organic solvent is covered with a wall made of a thermosetting resin.

The microcapsule slurry containing a microcapsule in which an oil containing a pesticidal active ingredient and an organic solvent is covered with a wall made of a thermosetting resin may be prepared, by using, for example, interfacial polymerization. The following explanation is made for the case where the wall of the microcapsule is made of a polyurethane resin.

A hydrophobic liquid containing the pesticidal active ingredient, the organic solvent and the polyisocyanate compound (hereinafter, referred to as “oil phase”), and an aqueous solution containing a dispersing agent and a polyol compound (hereinafter, referred to as “aqueous phase”) are mixed and dispersed by means of a disperser, to prepare a dispersion. The resultant dispersion is then heated and stirred to obtain a microcapsule slurry.

A use amount of the polyisocyanate compound is generally about 0.1 to 20% by weight, preferably about 0.2 to 10% by weight, and more preferably about 0.5 to 5% by weight, relative to the entire oil phase.

A concentration of the pesticidal active ingredient in the oil phase is generally about 5 to 90% by weight, preferably about 10 to 60% by weight, and more preferably about 20 to 50% by weight.

As the dispersing agent used in the aqueous phase, for example, water-soluble polymers are recited, and concrete examples include natural polysaccharides such as gum arabic, natural water-soluble polymers such as gelatin and collagen, water-soluble semi-synthetic polysaccharides such as carboxymethyl cellulose, methyl cellulose, hydroxypropyl cellulose, and a water-soluble synthetic polymer such as a polyvinyl alcohol and polyvinylpyrrolidone. A use amount of the dispersing agent is for example, about 0.05 to 30% by weight, and preferably about 0.5 to 20% by weight, in the entire aqueous phase.

A use amount of the polyol compound is generally about 2 to 30% by weight, preferably about 5 to 25% by weight, and more preferably about 10 to 20% by weight, relative to the entire aqueous phase. A ratio of the polyol compound and the polyisocyanate compound by ratio between a hydroxyl group and an isocyanate group (hereinafter, denoted by “OH/NCO”; mol ratio) is, for example, OH/NCO=1/1 to 5/1, and preferably OH/NCO=1/1 to 2/1.

The disperser is not particularly limited, and any of stirring-type dispersers (propeller stirrer, high-speed rotation stirrer, homogenizer, Homomic Line Flow and so on), stationary-type dispersers such as a static mixer, a line mixer, trade name “BUNSANKUN” (Fujikin Incorporated) and the like may be used. Two or more kinds of dispersers may be used in combination in such a manner that after mixing and dispersing an oil phase and an aqueous phase using a stirring-type disperser, further dispersing is conducted by a stationary-type disperser, for example.

A temperature at the time of heating the dispersion is typically 40 to 90° C., and preferably 60 to 80° C. A heating time is, for example, 1 to 96 hours, and preferably 24 to 72 hours.

When the wall of the microcapsule is made of a polyurea resin, a dispersion is prepared by mixing and dispersing a hydrophobic liquid (oil phase) containing a pesticidal active ingredient, an organic solvent and a polyisocyanate compound, and an aqueous solution (aqueous phase) containing a dispersing agent and a salt of polyamine compound by a disperser, and liquid property of the dispersion is adjusted to neutral or weak alkaline, followed by heating and stirring, to obtain a microcapsule slurry. In this case, a use amount of the polyamine compound is generally about 2 to 30% by weight, preferably about 5 to 25% by weight, and more preferably about 10 to 20% by weight, relative to the entire aqueous phase. A ratio of the polyamine compound and the polyisocyanate compound by ratio between an amino group and an isocyanate group (hereinafter, referred to as “NH₂/NCO”; mole ratio) is, for example, NH₂/NCO=1/1 to 5/1, and preferably NH₂/NCO=1/1 to 2/1. Other conditions are as same as those in the case of polyurethane resin.

A method of containing a thickener and at least one kind of ingredient selected from the group consisting of polyglycerin fatty acid ester, sucrose fatty acid ester and alkylbenzenesulfonic acid or its salt, in the microcapsule slurry thus obtained is not particularly limited, and the pesticidal composition of the present invention may be obtained, for example, by mixing a microcapsule slurry with a thickener solution containing a thickener and an additive added as necessary, and adding to this mixture, at least one kind of ingredient selected from the group consisting of polyglycerin fatty acid ester, sucrose fatty acid ester and alkylbenzenesulfonic acid or its salt after dilution with water as is necessary, followed by further mixing.

The pesticidal composition of the present invention may be used in a normal pesticidal spraying situation directly or after being diluted with water or the like of about 1 to 10000 times by weight per 1 part by weight of the pesticidal composition of the present invention.

The pesticidal composition of the present invention is sprayed, for example, to a plant body, soil and the like to be protected by the pesticidal active ingredient with the use of a plant sprayer. The plant sprayer sprays the pesticidal composition or its dilution in mist form under pressurizing, and those used in knapsack style, portable style, stationary style and running style, as well as that used by means of an unmanned helicopter are known. The pesticidal composition of the present invention is particularly suited for spraying to a plant body (leaf, stem and so on), and soil or the like.

In the following, the present invention will be described more specifically by way of Examples and Test Examples, however, the present invention will not be limited to these examples.

### EXAMPLE 1

90 g of pyriproxyfen, 100 g of a trade name “Hisol SAS-296” (mixture of 1-phenyl-1-xylylethane and 1-phenyl-1-ethylphenylethane, available from Nippon Oil Corporation) and 50 g of a trade name “VINYCIZER 40” (adipic acid diisobutyl ester, available from Kao Corporation) were mixed, and added with 2.4 g of a trade name “SUMIJULE N-3300” (isocyanurate-type polyvalent isocyanate, available from Sumika Bayer Urethane Co., Ltd.), to prepare an oil phase.

On the other hand, 17.5 g of gum arabic, 40 g of ethylene glycol and 344.4 g of ion exchange water were mixed, to prepare an aqueous phase.

The oil phase and the aqueous phase were mixed, and the resultant mixture was subjected to dispersion at 25° C. with the use of a homogenizer having a trade name “T.K. autohomomixer” (available from Tokusyukika Kogyo) for 5 minutes at about 6100 rpm. Then, the dispersion was stirred gently at 75° C. for 48 hours, to give a microcapsule slurry.

Then, a thickener solution prepared by mixing 1.5 g of xanthan gum, 3 g of aluminum magnesium silicate, 50 g of propylene glycol and 295.1 g of ion exchange water was mixed with the above microcapsule slurry, to obtain an aqueous suspension containing 9.0% by weight of pyriproxyfen.

1 g of an aqueous suspension was diluted with 999 g of ion exchange water, to prepare a diluted solution (hereinafter, called the diluted solution (A)). To the diluted solution (A), 1 g of a trade name “Ryoto (trademark)” polyglyester L-7D” (decaglycerin lauric acid ester, available from Mitsubishi-Kagaku Foods Corporation.) was added, to obtain an aqueous suspended pesticidal composition of the present invention (hereinafter, referred to as “Pesticidal composition (1)”).

### EXAMPLE 2

To the diluted solution (A), 1 g of a trade name “Ryoto (trademark) polyglyester M-10D” (decaglycerin myristic acid ester, available from Mitsubishi-Kagaku Foods Corporation.) was added, to obtain an aqueous suspended pesticidal composition of the present invention (hereinafter, referred to as “Pesticidal composition (2)”).

### EXAMPLE 3

To the diluted solution (A), 1 g of a trade name “Ryoto (trademark) polyglyester SWA-10D” (decaglycerin stearic acid ester, available from Mitsubishi-Kagaku Foods Corporation.) was added, to obtain an aqueous suspended pesticidal composition of the present invention (hereinafter, referred to as “Pesticidal composition (3)”).

### EXAMPLE 4

To the diluted solution (A), 1 g of a trade name “Ryoto (trademark) sugar ester P-1670” (sucrose palmitic acid ester, available from Mitsubishi-Kagaku Foods Corporation.) was added, to obtain an aqueous suspended pesticidal composition of the present invention (hereinafter, referred to as “Pesticidal composition (4)”).

### EXAMPLE 5

To the diluted solution (A), 1 g of a trade name “Ryoto (trademark) sugar ester S-1170” (sucrose stearic acid ester, available from Mitsubishi-Kagaku Foods Corporation.) was added, to obtain an aqueous suspended pesticidal composition of the present invention (hereinafter, referred to as “Pesticidal composition (5)”).

### EXAMPLE 6

To the diluted solution (A), 1 g of a trade name “Rhodacal (trademark) 70B” (branched-chain dodecylbenzenesulfonic acid potassium salt, available from Rhodia) was added, to obtain an aqueous suspended pesticidal composition of the present invention (hereinafter, referred to as “Pesticidal composition (6)”).

### COMPARATIVE EXAMPLE 1

To the diluted solution (A), 1 g of sodium dodecyl sulfate was added, to obtain an aqueous suspended pesticidal composition (hereinafter, referred to as “Comparative composition (1)”).

### TEST EXAMPLE

As a composition to be tested, each 5 mL of Pesticidal compositions (1) to (6), Comparative composition (1) and the diluted solution (A) was placed on a Petri Dish, dried at room temperature until the moisture is no longer present. Then pyriproxyfen present outside the microcapsule on the Petri Dish was collected by decane, and an elution amount of the pyriproxyfen was measured by gas chromatography (internal standard method).

An elution control index was determined by comparison with an elution amount in the test for the diluted solution (A) according to the following formula. The result is shown in Table 1.

Elution control index=(Elution amount of pyriproxyfen in each tested composition)/(Elution amount of pyriproxyfen in diluted solution (A))×100

TABLE 1

| Tested composition | Elution control index |
|---|---|
| Pesticidal composition (1) | 70 |
| Pesticidal composition (2) | 56 |
| Pesticidal composition (3) | 31 |
| Pesticidal composition (4) | 69 |
| Pesticidal composition (5) | 83 |
| Pesticidal composition (6) | 66 |
| Comparative composition (1) | 100 |
| Diluted solution (A) | 100 |

What is claimed is:

1. A pesticidal composition comprising:
a microcapsule in which an oil containing a pesticidal active ingredient and an organic solvent is covered with a wall made of a thermosetting resin;
at least one kind selected from the group consisting of polyglycerin fatty acid ester, sucrose fatty acid ester and alkylbenzenesulfonic acid or its salt;
a thickener, and water.

2. The pesticidal composition according to claim 1, wherein said thermosetting resin is a polyurethane resin or a polyurea resin.

3. The pesticidal composition according to claim 1, wherein said pesticidal active ingredient is an insect growth regulating active ingredient.

4. The pesticidal composition according to claim 3, wherein said insect growth regulating active ingredient is 4-phenoxyphenyl 2-(2-pyridyloxy)propyl ether.

5. The pesticidal composition according to claim 1, wherein the contents of the pesticidal active ingredient; the organic solvent; polyglycerin fatty acid ester, sucrose fatty acid ester and/or alkylbenzenesulfonic acid or its salt; the thickener; and the water are 0.0001 to 0.03%, 0.0002 to 0.06%, 0.01 to 1%, 0.0009 to 0.0002% and 99.9 to 99.998% by weight, respectively.
